(19) United States
(12) Patent Application Publication
(10) Pub. No.: US 2005/0205693 A1
(43) Pub. Date: Sep. 22, 2005

(54) Fuel injection valve for internal combustion engines

(76) Inventors: Werner Teschner, Stuttgart (DE); Claus Westphal, Grossbottwar (DE); Wilhelm Christ, Ludwigsburg (DE); Ulrich Bothe, Stuttgart (DE); Alexander Redlich, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/521,180

(22) PCT Filed: Apr. 29, 2003
(86) PCT No.: PCT/DE03/01370

§ 371 Date: May 25, 2005

(30) Foreign Application Priority Data
Jul. 16, 2002 (DE) 10232050.0

(51) Int. Cl. F02M 47/02; F02M 59/00; F02M 61/00; B05B 1/30

(52) U.S. Cl. 239/533.2; 239/585.5; 239/88

(57) ABSTRACT

A fuel injection valve for internal combustion engines, having a valve body in which a pistonlike valve needle is disposed in a bore is defined on its end toward the combustion chamber by a valve seat, which cooperates with a valve sealing face embodied on the valve needle, so that by the longitudinal motion of the valve needle, the opening of at least one injection opening embodied on the end toward the combustion chamber of the valve body is controlled. On the valve sealing face and/or on the valve seat, microscopic indentations are embodied.

### PRIOR ART

The invention is based on a fuel injection valve for internal combustion engines of the kind known from the prior art, such as German Published, Nonexamined Patent Application DE 196 18 650 A1. In a valve body, a bore is embodied in which a pistonlike valve needle, which on its end toward the combustion chamber has a valve sealing face, is longitudinally displaceably. On the end toward the combustion chamber, the bore is defined by a valve seat, with which the valve sealing face of the valve needle cooperates and thus by its longitudinal motion controls the opening of at least one injection opening which is embodied on the end toward the combustion chamber of the valve body.

The valve seat and the valve sealing face are embodied as at least substantially conical. Because of the short opening times of the fuel injection valve, the valve needle must be moved with very great forces, if suitably short switching times are to be attained. The valve needle therefore attains high speeds, with which, with its valve sealing face, it strikes the valve seat in the closing motion. Especially in so-called common rail injection systems, of the kind known for instance from German Patent Disclosure DE 198 27 267 A1, stringent demands are therefore made of the valve seat and the valve needle, if a high service life of the fuel injection valve and the most uniform possible injection characteristic over the entire service life are to be attained.

The motion of the valve needle in the bore is effected for instance by the exertion of a closing force on the valve needle in the direction of the valve seat. The opening force on the valve needle, oriented counter to the closing force, results from the subjection of fuel under pressure on the valve needle, whereupon some of the valve sealing face also experiences a hydraulically operative force. In the fuel injection valves known until now, seat wear occurs during operation; that is, the valve sealing face and the valve seat come to resemble one another over time, and the hydraulically operative partial area of the valve sealing face changes. As a result, the injection is no longer optimal, and increased exhaust emissions can occur.

In the high-pressure region of common rail fuel injection valves, which also includes the region of the valve seat, the injection events as a rule cause pressure fluctuations. As a result, between two injections, oscillating forces on the valve seat and the valve sealing face occur, which are superimposed on the high constant basic load from the constantly applied high pressure. As a result, wear, which impairs the service life of the fuel injection valve, occurs between the valve sealing face and the valve seat.

### ADVANTAGES OF THE INVENTION

The fuel injection valve of the invention having the definitive characteristics of claim 1 has the advantage over the prior art that the fuel injection valve has better drift behavior of the injection quantity and a longer service life. The valve sealing face of the valve needle and/or of the valve seat has microscopic indentations in the contact region, which lead to improved lubrication between the valve seat and the valve needle in the heavily loaded region. Purposefully adapting the microscopic indentations, which taken as a whole form microstructuring, to the tribologically relevant stress reduces wear at the valve seat and thus prolongs the life of the injection system.

In an advantageous feature of the subject of the invention, the microscopic indentations are embodied as individual dimples that are separate from one another. For a diameter of the individual dimples of 5 μm, for instance, which dimples are disposed in a rectangular grid with a spacing from one another also of 5 μm, up to 10,000 deposits of lubricant per mm² can be created. For a larger diameter of the dimples, there are correspondingly fewer of them per unit of surface area. The disposition of the dimples can also be optimized in such a way that the spacing of the dimples from one another in the circumferential direction of the valve sealing face or the valve seat differs from the spacing in the longitudinal direction.

In a further advantageous feature, the microscopic indentations are embodied as grooves or groove segments, which are either separate from one another or which in part overlap or intersect. In this respect it may be advantageous if the grooves extend over the entire circumference of the valve sealing face of the valve needle and/or of the valve seat, which is easy to achieve.

Because of the slight depth of the microscopic indentations, they can be made by various methods on the sealing face of the valve member. Examples for this are laser machining, hard turning, spark erosion, or lithographic methods. With these methods, a large number of lubricant deposits can be produced economically and in a short time.

Further advantages and advantageous features of the subject of the invention can be learned from the description and the drawing.

### DRAWING

In the drawing, one exemplary embodiment of the fuel injection valve of the invention is shown.

FIG. 1 shows a fuel injection valve in the essential region in longitudinal section;

FIG. 2 is an enlargement of the detail marked II in FIG. 1;

FIGS. 3a, 3b and 3c, an enlargement of FIG. 2 in the detail marked III, for various exemplary embodiments; and

FIG. 4 shows the same view as FIG. 2, with screws as the microscopic indentations.

### DESCRIPTION OF THE EXEMPLARY EMBODIMENT

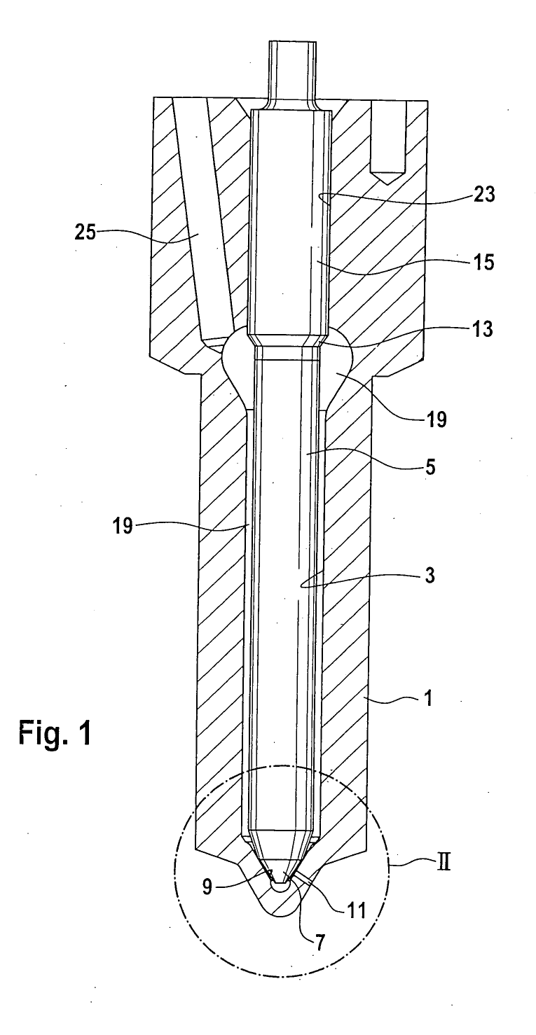

In FIG. 1, one exemplary embodiment of the fuel injection valve of the invention is shown in longitudinal section in its essential portion. In a valve body 1, a bore 3 is made in which a pistonlike valve needle 5 is disposed longitudinally displaceably. The valve body 1 is disposed here in an internal combustion engine, not shown in the drawing, so that with its end toward the combustion chamber it protrudes into the combustion chamber of the engine or forms part of the wall of the combustion chamber. Remote from the combustion chamber, the valve needle 5 has a guide portion 15, which is guided sealingly in a guide region 23 of the bore 3. Beginning at the guide portion 15, the valve needle 5 tapers toward the combustion chamber, forming a pressure shoulder 13, which surrounds the valve needle 5 over its entire circumference. On its end toward the combustion chamber, the valve needle 5 changes over into a substantially conical valve sealing face 7, which cooperates with a valve seat 9 which is likewise shaped essentially conically and which defines the bore 3 on its end toward the combustion chamber. In the valve seat 9, at least one injection opening 11 is embodied, which connects the valve seat 9 with the combustion chamber of the engine. Between the valve needle 5 and the wall of the bore 3, a pressure chamber 19 is embodied, which is radially enlarged at the level of the pressure shoulder 13; an inlet conduit 25 embodied in the valve body 1 discharges into this radial enlargement. Via the inlet conduit 25, the pressure chamber 19 can be filled with fuel at high pressure, which then flows through the pressure chamber 19 and thus reaches the valve seat 9.

By means of a device not shown in the drawing, a constant or chronologically varying closing force is exerted on the end toward the combustion chamber of the valve needle 5, so that the valve needle 5 is pressed with its valve sealing face 7 against the valve seat 9. This closing force acts counter to the hydraulic force that is exerted by the fuel pressure in the pressure chamber 19 on the pressure shoulder 13 and on parts of the valve sealing face 7. For controlling the longitudinal motion of the valve needle 5 in the bore 3, both of these forces are employed. If the hydraulic force on the valve needle 5 exceeds the closing force, then with its valve sealing face 7 the valve needle 5 lifts from the valve seat 9, and fuel flows out of the pressure chamber 19 through the injection openings 11 into the combustion chamber of the engine. If the closing force is increased or the hydraulic force is reduced, then the closing force on the valve needle 5 predominates, and with its valve sealing face 7 the valve needle 5 moves into contact with the valve seat 7, as a result of which the injection openings 11 are closed.

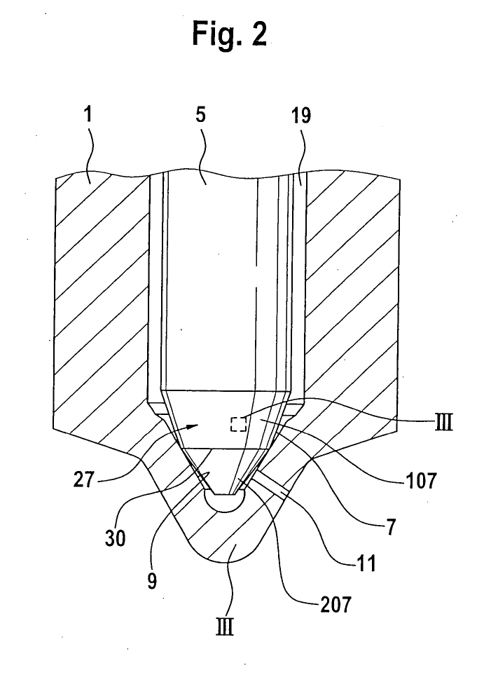

FIG. 2 shows an enlargement of the detail marked II in FIG. 1, that is, an enlargement of the valve seat region of the fuel injection valve. The valve sealing face 7 is divided into two conical faces, of which the first conical face 107 directly adjoins the cylindrical portion of the valve needle 5, while the second conical face 207 borders the first conical face 107 and forms the tip of the valve needle 5. The first conical face 107 has a larger opening angle than the second conical face 207, so that a sealing edge 30 is formed at the transition between the two conical faces 107 and 207. The valve seat 9 has an opening angle that is between the opening angle of the first conical face 107 and the opening angle of the second conical face 207, so that in the closing position of the valve needle 5, the sealing edge 30 comes to rest on the valve seat 9. The injection openings 11, a plurality of which are as a rule distributed over the circumference of the valve body 1, are disposed downstream of the sealing edge 30, so that they can be closed by the valve needle 5.

The switching times of the valve needle 5 are very short: Since in high-speed internal combustion engines of the kind used in passenger cars, there can be more than 2000 injections per minute, one injection event lasts only approximately 1 ms. Strong forces and hence high accelerations therefore act on the valve needle 5 and cause the valve needle 5 to strike the valve seat 9 at high speed; in operation of the fuel injection valve, the sealing edge 30 is hammered into the valve seat 9 somewhat as a result, resulting in an adaptation between the valve sealing face 7 and the valve seat 9. The valve sealing face 7 and the valve seat 9 are therefore extremely heavily loaded mechanically. On the one hand, the seat region of the valve body 1 must not be excessively hard, so as to preclude breakage in this region. On the other hand, the sealing edge 30 not be hammered excessively into the valve seat 9 in operation, since in that case the partial area of the valve sealing face 7 acted upon by fuel in the pressure chamber 19 would change and hence also the pressure at which the valve needle 5 is moved in the opening direction counter to the closing force would change. A change in this opening pressure also causes a change in the entire dynamics of opening, so that a precise injection is no longer assured.

In injection valves in which high fuel pressure constantly prevails in the pressure chamber and hence also at the valve seat, pressure fluctuations result in still further stress. As a result of the closure of the valve needle, the fuel in the pressure chamber, which is flowing toward the valve seat, is braked abruptly, so that the kinetic energy is converted into compression work, and as a consequence, pressure fluctuations occur, leading to a periodic stress in the region of the valve seat and the valve sealing face. Fuel injection valves stressed in this way are used primarily in common rail injection systems. Moreover, in fuel injection valves in which the closing force on the valve needle is generated by the hydraulic pressure in a control chamber, pressure fluctuations can occur in this control chamber, which once again can lead to periodic forces on the valve needle in its closing position.

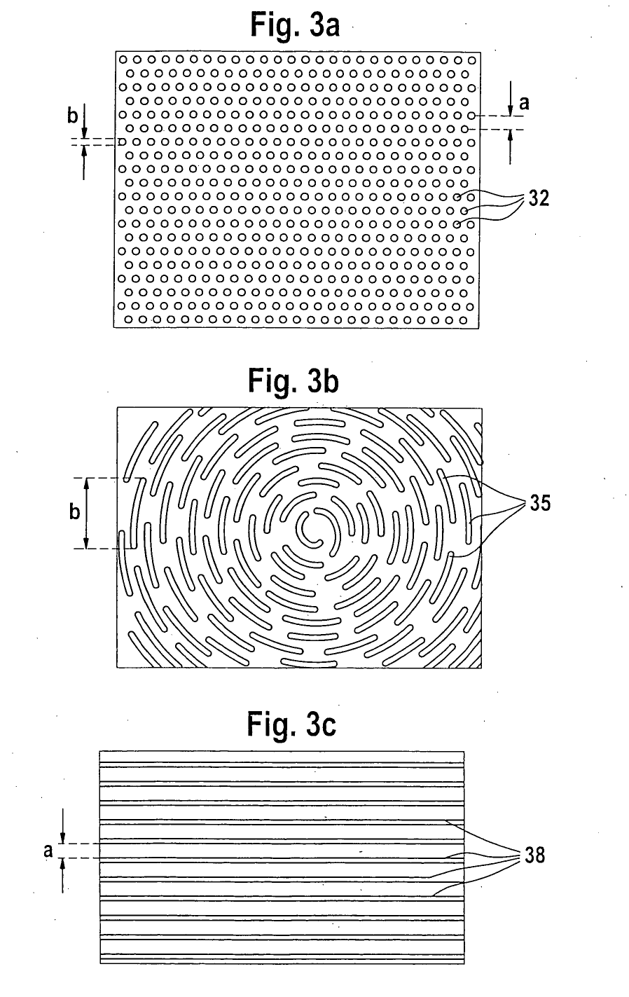

To reduce the wear at the boundary face between the valve sealing face 7 and the valve seat 9 and thus to increase the service life, microscopic indentations are embodied on the valve seat 9 or on the valve sealing face 7. FIG. 3a shows a first exemplary embodiment, in which an enlarged detail of the valve sealing face 7 is shown that is marked III in FIG. 2. The valve sealing face 7 is covered with dimples 32, which are embodied individually and are spaced apart from one another. The dimples 32 are circular microscopic indentations, which in this example are disposed in a rectangular pattern. The depth of the dimples is 0.5 μm to 50 μm, and a depth of 3 μm to 20 μm is especially advantageous. The dimples have a diameter between 5 μm and 100 μm, and a size of 10 μm to 50 μm has proved especially advantageous. The spacing of the dimples 32 from one another is in the range from 5 μm to 500 μm, but in certain cases can also be outside that range.

By means of the dimples 32, a fuel lubricant film is kept on the valve sealing face 7, so that even when the valve needle 5 is closed, or in other words when this valve needle is resting on the valve seat 9, adequate lubrication between these components is assured. The wear between the valve sealing face 7 and the valve seat 9, when various operating states of the fuel injection valve lead to pressure fluctuations in the pressure chamber 19 and hence deformation of the valve body 1 in the region of the valve seat 9, is thus reduced. The same wear-reducing effect is attained if such dimples 32 are embodied in the valve seat 9 as well as in the valve sealing face 7. It may also be provided that dimples 32 and hence a microstructure are formed only in the valve seat 9, but in general it would be easier to embody a microstructure on the valve sealing face 7 of the valve needle 5, since that face is more easily accessible.

FIG. 3b shows a further exemplary embodiment for microscopic indentations in the valve sealing face 7; the detail shown is the same as in FIG. 3a. Instead of dimples, groove segments 35 are embodied here, which in this example are arranged concentrically around a center. The groove segments 35 create a preferential direction, so that the lubricating action of these microscopic indentations can be optimized by means of a suitable orientation on the valve sealing face 7. Once again, it may be provided that the groove segments 35 are also, or exclusively, on the valve seat 9, depending on what is more suitable for the lubricating action or involves less cost.

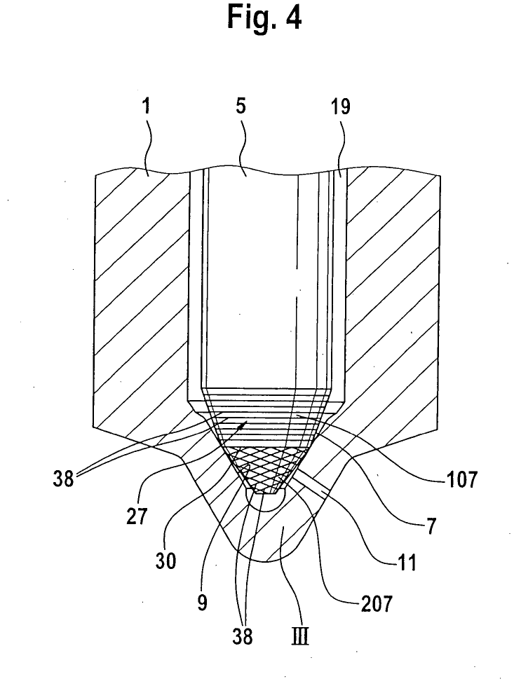

FIG. 3c shows a further exemplary embodiment of the microscopic indentations, embodied here as grooves 38. The detail shown corresponds in size to FIGS. 3a and 3b. The grooves 38 extend for example parallel to one another and in a tangential direction on the valve sealing face 5. This is shown in FIG. 4 on the first conical face 107, as an example. However, it may also be provided that the grooves intersect, as is shown in FIG. 4 on the other conical face 207. Once again, the lubricating properties can be adjusted and thus optimized by means of the orientation, width, and depth of the grooves 38.

The production of the microscopic indentations 32, 35, 38 can be done by various techniques. For grooves 38, fine turning, hard turning, or jet machining is suitable. Dimples 32 may for instance be made by microembossing, spark erosion, or by lithographic or electrochemical methods. The same methods are also suitable for making the groove segments 35. Once the microstructure has been made in the valve sealing face 7 or the valve seat 9, it is provided that the surface be post-treated, for instance by lapping, fine polishing, or finishing. Which method will be selected in an individual case depends on the type of microscopic indentations, on the material, and on the size of the face to be machined.

1-16. (canceled)

17. A fuel injection valve for internal combustion engines, comprising
a valve body (1) having a bore (3),
a pistonlike valve needle (5) disposed in the bore (3),
a valve seat (9), embodied on the end of the bore (3) toward the combustion chamber
a valve sealing face (7) embodied on the valve needle (5) and cooperating with the valve seat (9) whereby, by the longitudinal motion of the valve needle (5), the opening of at least one injection opening (11) embodied on the end toward the combustion chamber of the valve body (1) is controlled, and
microscope indentations (32; 35; 38) on the valve sealing face (7) and/or the valve seat (9).

18. The fuel injection valve of claim 17, wherein the microscopic indentations (32; 35; 38) are embodied individually and are separate from one another.

19. The fuel injection valve of claim 18, wherein the microscopic indentations (32; 35; 38) are embodied as dimples (32).

20. The fuel injection valve of claim 19, wherein the dimples (32), viewed in the circumferential direction of the valve needle (5), have a lesser spacing between one another than in the longitudinal direction of the valve needle (5).

21. The fuel injection valve of claim 19, wherein the dimples (32), viewed in the circumferential direction of the valve sealing face (7), have a greater spacing between one another than in the longitudinal direction of the valve needle (5).

22. The fuel injection valve of claim 18, wherein the microscopic indentations (32; 35; 38) have a spacing (a) from one another of between about 5 μm and 500 μm.

23. The fuel injection valve of claim 17, wherein the microscopic indentations (32; 35; 38) are embodied as grooves (38).

24. The fuel injection valve of claim 17, wherein the microscopic indentations (32; 35; 38) are embodied as groove segments (35).

25. The fuel injection valve of claim 23, wherein the microscopic indentations (32; 35; 38) intersect at least in part.

26. The fuel injection valve of claim 24, wherein the microscopic indentations (32; 35; 38) intersect at least in part.

27. The fuel injection valve of claim 23, wherein the microscopic indentations (32; 35; 38) extend in concentric circles over the entire circumference of the valve sealing face (7) and/or of the valve seat (9).

28. The fuel injection valve of claim 24, wherein the microscopic indentations (32; 35; 38) extend in concentric circles over the entire circumference of the valve sealing face (7) and/or of the valve seat (9).

29. The fuel injection valve of claim 17, wherein the microscopic indentations (32; 35; 38) overlap at least in part.

30. The fuel injection valve of claim 17, wherein the microscopic indentations (32; 35; 38) have a depth between about 0.5 μm and 50 μm.

31. The fuel injection valve of claim 17, wherein the microscopic indentations (32; 35; 38) have a depth between about 3 μm and 20 μm.

32. The fuel injection valve of claim 17, wherein the microscopic indentations (32; 35; 38) have a width (>) of between about 5 μm and 100 μm, preferably between 10 μm and 50 μm.

33. The fuel injection valve of claim 17, wherein the microscopic indentations (32; 35; 38) are produced by jet machining, laser machining, hard turning, microembossing, spark erosion, or by lithographic or electrochemical methods.

34. The fuel injection valve of claim 23, wherein the grooves (38) are produced by fine turning.

35. The fuel injection valve of claim 30, wherein the microscopic indentations (32; 35; 38) are made after the fine machining of the valve sealing face (7) and of the valve seat (9) and the faces are subsequently postmachined by lapping, fine polishing or finishing.

36. The fuel injection valve of claim 31, wherein the microscopic indentations (32; 35; 38) are made after the fine machining of the valve sealing face (7) and of the valve seat (9) and the faces are subsequently postmachined by lapping, fine polishing or finishing.
